(19) United States
(12) Patent Application Publication
(10) Pub. No.: US 2006/0265352 A1
(43) Pub. Date: Nov. 23, 2006

(54) Methods and apparatus for information integration in accordance with web services

(75) Inventors: Mao Chen, Elmsford, NY (US); Mitchell A. Cohen, Yorktown Heights, NY (US); Rakesh Mohan, Cortlandt Manor, NY (US)

Correspondence Address: Ryan, Mason & Lewis, LLP, 90 Forest Avenue, Locust Valley, NY, 11560, US

(73) Assignee: International Business Machines Corporation, Armonk, NY (US)

(21) Appl. No.: 11/133,540

(22) Filed: May 20, 2005

(51) Int. Cl. G06F 17/30

(52) U.S. Cl. 707/2

(57) ABSTRACT

Techniques are disclosed for improved information integration in accordance with information sources such as web services in a distributed information system. For example, a technique for processing a query obtained from a user in an information integration system, wherein the information integration system is associated with a database and one or more information sources, comprises the following steps/operations. The user query is transformed to one or more queries valid with respect to one or more of the information sources associated with the database. Based on the one or more transformed queries, a query plan executable on the database is generated, wherein at least a portion of results returned to the user in response to the query are based on at least a portion of results returned from execution of the query plan. In one embodiment, the information sources may be web services. Further, a number, a nature and/or an identity of the one or more information sources may be dynamic or change over time.

### FIELD OF THE INVENTION

This present invention generally relates to distributed information systems and, more particularly, to techniques for information integration in accordance with web services in a distributed information system.

### BACKGROUND OF THE INVENTION

Integrating information from heterogeneous sources has been an important problem in very large database management environments such as in distributed information systems, e.g., the Internet or the World Wide Web (“web”). Systems for integrating such information can be classified as “query-centric” or “source-centric.” The query-centric systems choose a set of users' queries and provide the procedure to customize those queries for the available sources. The source-centric systems describe sources' contents and query capabilities, and transform each new query based on the descriptions. Both types of systems focus on query planning optimization using certain criteria, but use light-weight transformation between different concept spaces of the sources.

One problem associated with these integration systems is that the query plans are not optimized at the execution level. In contrast, some commercial databases (e.g., International Business Machines Corporation's (Armonk, N.Y.) DB2 Information Integrator or DB2 II) have powerful query planning engines that use sophisticated algorithms based on execution cost, statistics on usage, and other parameters with regard to the running environment. In addition, those systems usually rely on ad-hoc wrapper languages and models, which make adding a new service in such an integration system a heavy burden on the service provider side.

Another drawback with respect to all previous integration systems is that the set of information sources is assumed to be static: in their identity, schema and data format. On the web, a more variable and dynamic scenario exists where new information providers appear and old ones either go out of business and disappear or change the format or type of information system they provide. In such a dynamic situation on the web, in any of the existing information integration systems, a user query which is valid with a given set of information sources, will not work at a later time when the information sources have changed.

### SUMMARY OF THE INVENTION

Principles of the present invention provide techniques for improved information integration in accordance with information sources such as web services in a distributed information system.

For example, in one aspect of the invention, a technique for processing a query obtained from a user in an information integration system, wherein the information integration system is associated with a database and one or more information sources, comprises the following steps/operations. The user query is transformed to one or more queries valid with respect to one or more of the information sources associated with the database. Based on the one or more transformed queries, a query plan executable on the database is generated, wherein at least a portion of results returned to the user in response to the query are based on at least a portion of results returned from execution of the query plan.

In one embodiment, one or more of the information sources may comprise one or more web services. Further, at least one of a number, a nature and an identity of the one or more information sources may be dynamic or change over time.

The query transformation step/operation may further comprise using an ontology language to describe at least one of a concept space of the user, a concept space of the one or more information sources, and relations between different concept spaces. The query transformation step/operation may further comprise transforming the user query, based on semantic annotations on the one or more information sources, to the one or more valid queries to the one or more information sources by reasoning from the ontology. Still further, the query transformation step/operation may further comprise using a knowledge base for describing information that cannot be described using the ontology language. The knowledge base may describe information relating to mathematical relations between concepts. The query transformation step/operation may further comprise one or more of concept mapping, instance mapping, concept folding, instance folding, an inequality inference rule, a knowledge-based reasoning rule, and a rule for handling a mismatch in a searchable attribute.

The executable query plan generation step/operation may further comprise selecting candidate information sources to answer the user query. A valid query may be generated for each candidate information source. Information sources whose output schema are consistent may be grouped. Results associated with related information sources may be joined.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating an information integration system for web services, according to an embodiment of the present invention;

FIG. 2 is a diagram illustrating an information integration methodology for web services, according to an embodiment of the present invention;

FIGS. 3A through 3I are diagrams illustrating tables associated with a used car searching application for use in explaining an information integration methodology for web services, according to an embodiment of the present invention;

FIG. 4 is a diagram illustrating a concept mapping process, according to an embodiment of the present invention;

FIG. 5 is a diagram illustrating a concept folding process, according to an embodiment of the present invention;

FIG. 6 is a diagram illustrating an instance folding process, according to an embodiment of the present invention;

FIG. 7 is a diagram illustrating transformations between comparison operators, according to an embodiment of the present invention;

FIG. 8 is a diagram illustrating a method of generating an executable query to a back-end database, according to an embodiment of the present invention; and

FIG. 9 is a diagram illustrating a computing system in accordance with which one or more components/steps of an information integration system may be implemented, according to an embodiment of the present invention.

### DETAILED DESCRIPTION OF PREFERRED EMBODIMENTS

The present invention will be explained below in the context of an illustrative Internet or web-based environment, more particularly, a web services environment. However, it is to be understood that the present invention is not limited to such Internet or web implementations. Rather, the invention is more generally applicable to any information retrieval environment in which it would be desirable to provide improved access to information from heterogeneous sources. In the illustrative embodiments described below, a web service is considered an example of an information source.

As specified by the World Wide Web Consortium or W3C (see, e.g., www.w3c.org/2002/ws/), “web services” provide a standard mechanism for interoperating between different software applications, running on a variety of platforms and/or frameworks. More particularly, it is known that web services provide a standardized way of integrating web-based applications using the Extensible Markup Language (XML), Simple Object Access Protocol (SOAP), Web Service Description Language (WSDL) and Universal Description, Discovery and Integration (UDDI) open standards over an Internet protocol backbone. Typically, XML is used to tag the data, SOAP is used to transfer the data, WSDL is used for describing the services available, and UDDI is used for listing what services are available (see, e.g., www.webopedia.com).

As is further known, the web service framework provides a machine-usable interface to “wrap” information sources that are conventionally accessible only via human-understandable query forms. Via a web service wrapper, any structured databases, file systems, unstructured web pages and other information sources can be treated equally in Internet-scale information integration. The applications of web-service supported information integration include internal integration applications within a global enterprise and many Internet-scale, business-to-customer (B2C) and business-to-business (B2B) services.

Different from traditional full-fledged and stable information sources such as databases, web services are distinct in their heterogeneity and dynamics. First, web services are heterogeneous in content. For a given user query, multiple information sources that are wrapped by web services usually provide only part of the answer. In addition, web services have different query capabilities, which are reflected in the various query schemas used by web services. Furthermore, web services are highly dynamic in the sense that new services are added continuously, old services may become unavailable, and existing services are updated frequently in terms of the query interface and the contents.

As will be described, in an illustrative embodiment of the invention, an improved web services framework for information integration is provided. This illustrative framework is compatible with industry standards and commercial database systems. In a particular embodiment, the illustrative framework uses a database system available from International Business Machines (IBM) Corporation (Armonk, N.Y.) referred to as “DB2 Information Integrator” or “DB2 II” for interfacing to web services and generating an optimized query plan to multiple sources.

In the illustrative embodiment, the user specifies her query in her concept space. The system then transforms the user's query to a valid Structured Query Language (SQL) query over virtual tables to which DB2II maps the web services. The query transformation comprises two phases. The first phase customizes a user query into the queries to the web services. The transformation results are used in the second phase to generate an executable query plan as an input to DB2 II.

In the illustrative embodiment, the query transformation algorithm uses an ontology language to describe a user's concept space, the concept space of the web services, and the relations between different concept spaces. By way of example, an “ontology” may refer to a formal specification of how to represent objects, concepts and other entities that are assumed to exist in some area of interest and the relationships that hold among them. In terms of a web site, an ontology may refer to a general framework for describing, among other things, the web site's metadata (e.g., the information about the information on the site).

Based on the semantic annotations on the web services, a user query is transformed to the queries to the various web services by reasoning from the ontology. We use a used car searching service as an example to describe an information integration framework according to an illustrative embodiment of the invention.

Accordingly, as will be explained herein, illustrative principles of the invention provide, inter alia: (i) a framework for Internet-scale information integration using web services, ontology language and commercial databases; (ii) a set of reasoning rules to transform between different schemas of heterogeneous domain-specific (e.g., used car domain) searching services; and (iii) an ontology-based annotation scheme for describing web services as information sources.

Advantageously, an integration model that leverages existing industry standards for describing heterogeneous web information sources is provided. Different from conventional integration systems, the methodology takes advantage of the query optimization capabilities of a commercial database system, DB2II in an illustrative embodiment, and therefore guarantees efficient queries on heterogeneous sources. Furthermore, web services can be added or removed without recoding the integration engine and the wrappers, thus making the system well suited for the dynamic environment of the web.

For ease of reference, the remainder of the detailed description will be subdivided into the following sections. Section 1 outlines an illustrative architecture of the information integration framework. Section 2 describes an illustrative query transformation methodology. Section 3 illustrates functionality of the query transformation methods using an example. Section 4 describes an illustrative computing system for use in implementing all or part of the information integration framework.

1. Illustrative Architecture of Integration Engine for Web Services

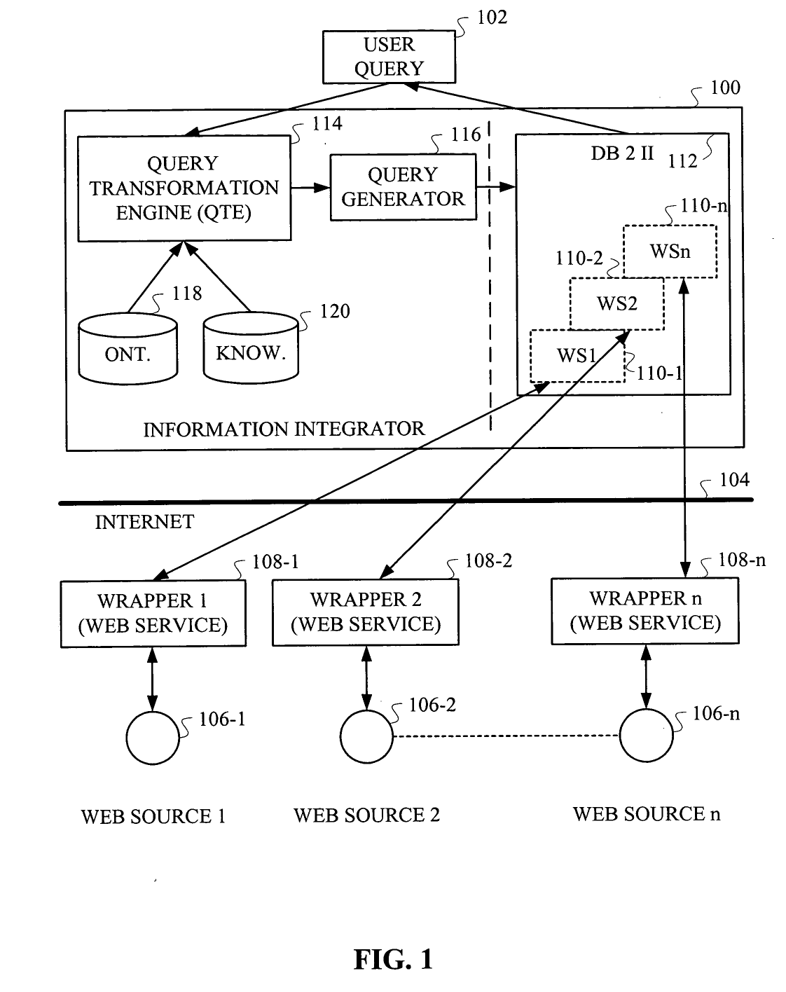

FIG. 1 depicts an information integration system for web services, according to an illustrative embodiment of the invention. As shown, in general, information integrator 100 is operatively coupled between one or more client devices (not shown), from which one or more user queries 102 may originate, and the Internet 104. Web sources 106-1 through 106n are also shown as being coupled to the Internet 104.

Each web source is wrapped and presented using a web service interface (108-1 through 108-n). Each service is mapped to virtual tables (110-1 through 110-n) in a DB2 database 112. The attributes (e.g., columns) of the virtual tables include both the input and the output attributes of the web service.

This information integration system 100, itself, comprises three modules. The front end of the system (delineated by the vertical dashed line) has a query transformation engine (QTE) 114 and a query generator 116. The back-end includes database 112.

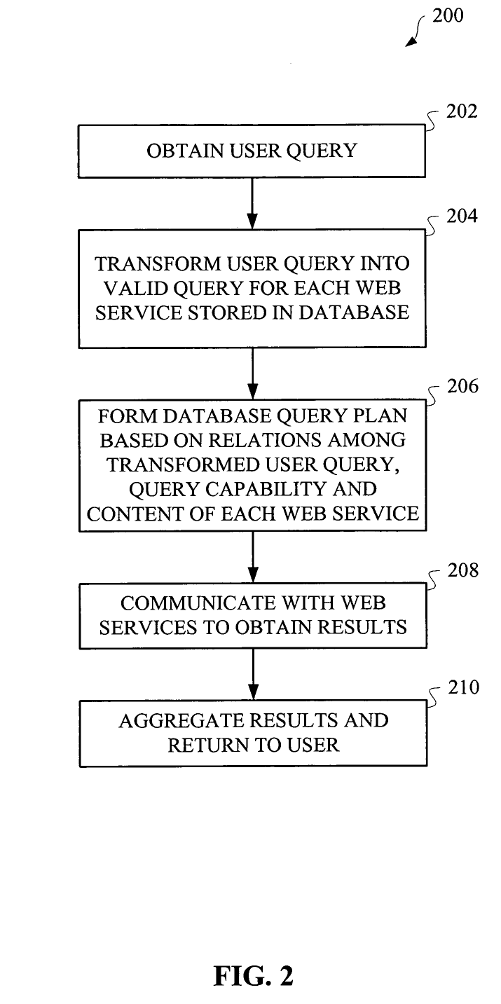

Note that reference will also be made below to FIG. 2 which illustrates a query processing methodology 200, according to an illustrative embodiment of the present invention.

When a user's query comes in (step 202), QTE 114 customizes or transforms (step 204) the user query into the valid queries against the web services whose schemas are described as tables in the back-end database 112 (DB2 II). The transformation algorithm of QTE 114 relies on the semantic information about the services, and will be described in more detail below in Section 2. The ontology-based source 118 (labeled “Ont.”) describes the query capability of each service and the relations between different concepts. The knowledge base 120 (labeled “Know.”) stores the information that cannot be described using the ontology language, for example, the mathematical relation between the concepts. Based on the transformation result, query generator 116 creates an executable query on all the related web services (e.g., 108-1 through 108-n) and triggers DB2 II with the query.

At the back end of the integration framework resides the DB2 II database system 112 which has the capability of integrating multiple web services together and generates optimized queries on them (step 206). Using the final query plan generated by DB2 II, integration system 100 communicates with all the related web services (step 208) and returns the aggregated results to the end users (step 210).

Given the query optimization capability of a commercial database system such as the DB2 II, major challenges of the above infrastructure include annotating web services about their query capabilities, automatically transforming user query to the valid query for each web service, and generating an executable query plan for DB2 II. The next section describes techniques which address these issues and achieve such goals.

2. Semantic-based Query Transformation

As mentioned above, a used car searching service is used as an exemplary application scenario in order to explain the integration framework. However, principles of the invention are not limited to any particular application or domain.

In this illustrative service scenario, given a user query on used car information, this service intelligently inquires and integrates the results from three web sites, Yahoo™ Autos, Autos MSN™ and Kelly's Blue Book™. Yahoo™ and MSN™ provide on-line retailing and auction information about the used cars. A user can search the used cars listed at the two sites. Kelly's Blue Book™ is an authority site that provides a suggested retail price for a car when given make, model, year and trim information.

A user's concept space about used car information includes the query part and the result part. A user can search for used cars based on the user's location, searching area, make and model, year, mileage and price. The most interesting results to a user are year, mileage, asked price, KBB (Kelly's Blue Book™) suggested price. Other information such as trim, location, and color may also be desirable.

A main function of the information integration system 100 that uses DB2 II as the back-end is to transform an SQL-like user query as follows:

SELECT*FROM car

WHERE make=‘Acura’ AND price<=15000 AND mileage <=100000 into a valid query of DB2 II that stores the aforementioned web services:

SELECT automake, automodel, mileage, price FROM YahooAuto

WHERE automake=‘Acura’ AND maxprice=15000

AND maxmiles=100000

UNION ALL

SELECT carmake, carmodel, year, mileage, price

FROM MSNCars

WHERE category=‘Passenger Cars’ AND carmake=‘Acura’ AND maxprice=15000 AND mileage=100000

The above transformation comprises two phases. Phase 1 transform a user's query into the valid query for each web service stored in the database (e.g., step 204 of FIG. 2). In phase 2, a DB2 II query is formed based on the relations among the user's query, the query capability and the contents of each web service (e.g., step 206 of FIG. 2).

2.1 Describing Web Services as Ontology

In this illustrative embodiment, the semantic information about web services is described using ontology that is generated using the Protégé™ ontology editor and knowledge acquisition system. Protégé™ was developed by Stanford Medical Informatics at the Stanford University School of Medicine. The resulting ontology is represented as RDF (Resource Description Framework) and RDFS (RDF Vocabulary Description Language) files. However, the invention is not limited to any particular ontology editor, knowledge acquisition system, or result representation.

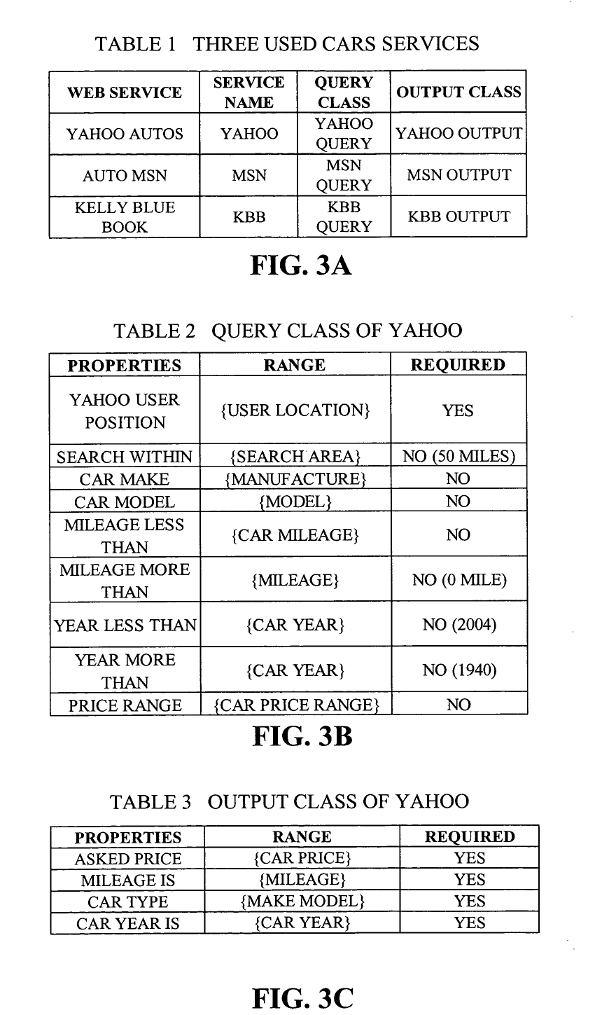

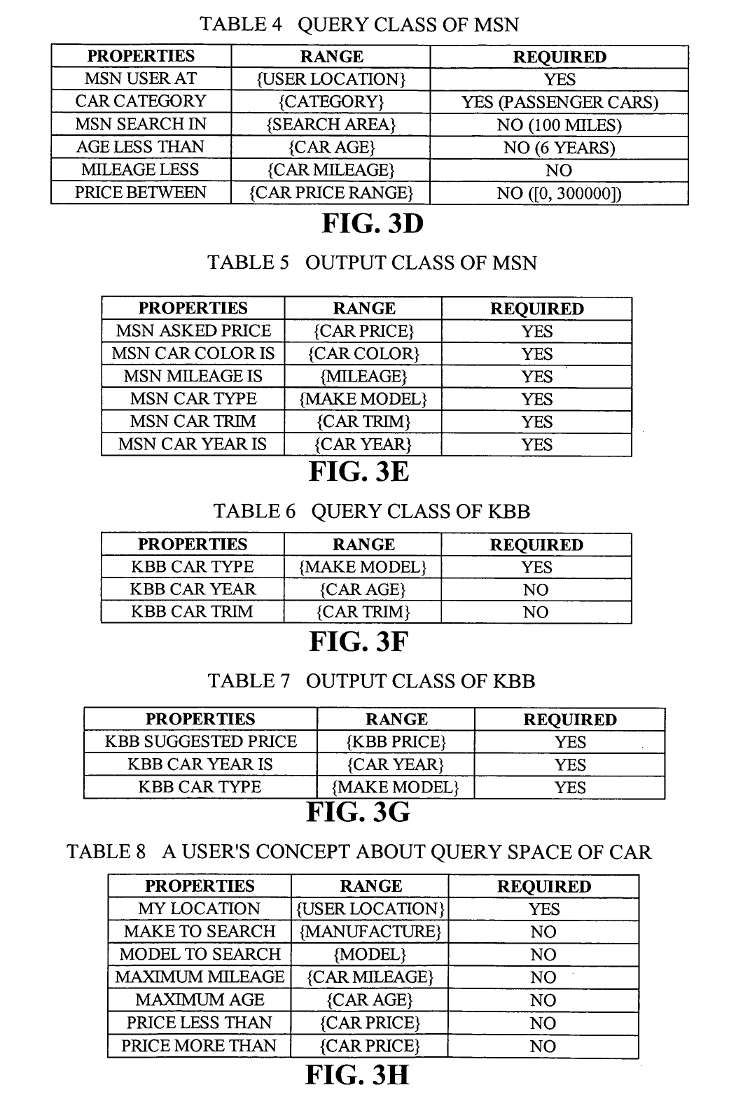

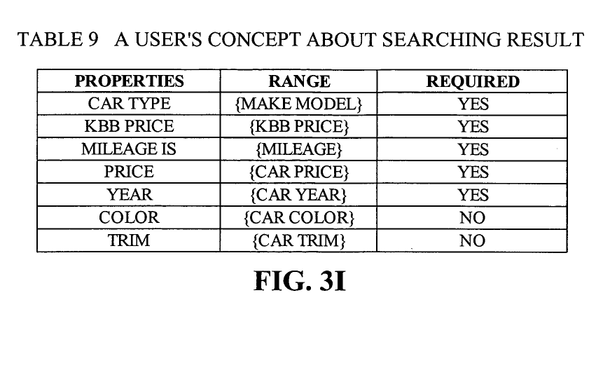

A web service is described as the class “web source” which has three properties: the service name, the query class (input schema), and the output class (output schema). Each actual web service is an instance of this class. Table 1 in FIG. 3A lists the three web services considered in the used car example.

The query class of Yahoo™ Autos is defined in table 2 in FIG. 3B. Table 2 also shows that only the user position in the form of a zip code is required in the queries to Yahoo™ Autos. The output class of Yahoo™ Autos is shown in table 3 in FIG. 3C.

Tables 4, 5, 6, and 7 (FIGS. 3D, 3E, 3F and 3G, respectively) present the classes for describing the input and the output schemas of MSN™ and KBB™.

A user's concept about searching used car service is shown in tables 8 and 9 (FIGS. 3H and 3I, respectively).

2.2 Transforming User Query to the Queries to the Web Services

Heterogeneous schemas cause mismatch between a user's query and that of the web services. We present herein below seven illustrative transformation cases, and present solutions for dealing with each case using ontology-based reasoning. However, the invention is not limited to any particular transformation case.

The first four transformations demonstrate two pairs of dual transformations at abstract model level and at instance model level, while the fifth and the sixth rules process the transformation between different abstract models. The last rule handles the mismatches in searchable attributes at both abstract and instance levels.

2.2.1 Concept Mapping

One of the most common difficulties in dealing with heterogeneous schemes is that a same concept has different names in different sources. This mismatch can be handled using concept mapping or renaming.

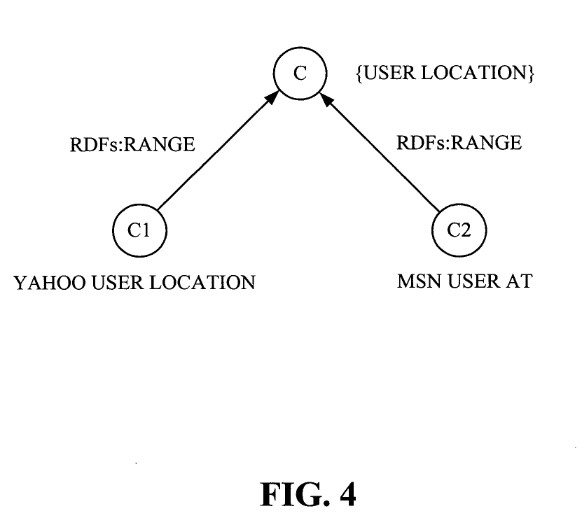

Principles of the invention achieve renaming by mapping different names to a common concept using RDFs:range. FIG. 4 demonstrates an illustrative concept mapping method to figure out two equivalent concepts “Yahoo User Location” and “MSN™ User at” via the class “User Location.” If the ontology description language OWL (OWL Web Ontology Language Reference, www.w3c.org/TR/2004/REC-owl-ref-20040210) is used, the equivalence of the two properties in FIG. 4 can be indicated by “OWL:EqualProperty” directly.

2.2.2 Instance Mapping

In practice, the same instance may have different names in different models. For example, “New York” and “NY” refer to the same state instance. Instance mapping is used to find out the equivalent instances so that an instance in one model can be transformed to the equivalent instance in another model.

Instance mapping can be achieved by using the “OWL:sameAs” mechanism to indicate equivalent instances. For example, the following example shows the equivalence of “New York” and “NY”:

<UsedCar rdf:ID=“New York”>
<owl:sameAs rdf:resouree---“#NY” />
</UsedCar>

2.2.3 Concept Folding

Different sources may allow queries at different levels of granularity for a given attribute. For example, Kelly's Blue Book™ requires queries on “Car Type” which combines “Manufacture” and “Model” as a single attribute. On the other hand, Yahoo™ allows queries to specify “Make” and “Model” separately. We refer to the transformation function from fine-grained concepts to a coarser-grained concept as concept folding.

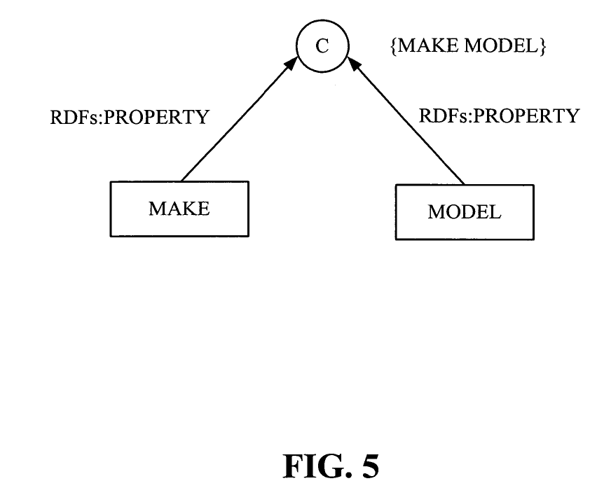

In an information integration system of the invention, concept folding may be achieved by annotating fine-grained concepts as properties of the coarse-grained concept. FIG. 5 illustrates the annotations used to fold the concepts “Make” and “Model” as “Make Model.” If OWL is used as the annotation language, the two concepts “Make” and “Model” can be defined as “sub property” of the property “Make Model.”

Given a part of a user's query as follows:

Where Make=“Acura” and Model=“CL”

concept folding generates a query on “Make Model”=“Acura CL” to satisfy the query capability of KBB™.

2.2.4 Instance Folding

Different from concept folding that merges fine-grained concepts into an equivalent single concept, instance folding or concept expanding extends an instance into a more general instance.

Assume a user's query is on “Make” and “Model,” but a service provider such as MSN™ supports car searching only on “Car Category.” A car category includes many car types. Hence, the query transformation needs to extend a specific car type searching into a more general category searching.

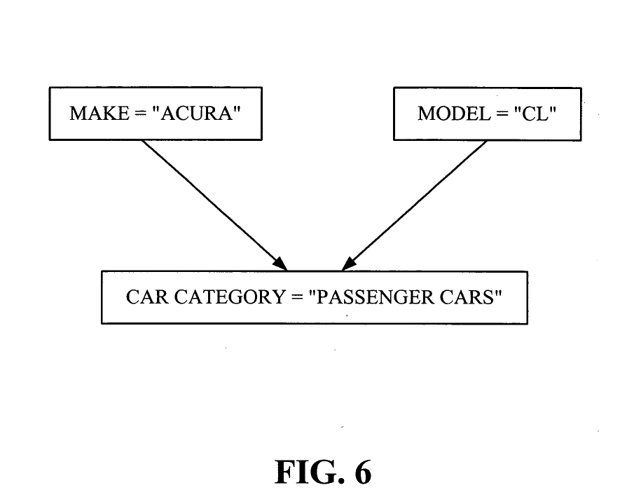

We define the class “Car category” with two properties that are “Make” and “Model.” This definition indicates any car in a certain “Car category” can be also identified by “Make” and “Model.” The relation between each category and each pair of make and model is described by the instances in the RDF ontology file. The knowledge represented in FIG. 6 is used to transform a user's query such as:

Where Make=“Acura” and Model=“CL”

into the following query valid on MSN™:

Where Car Category=“Passenger Cars”

Instance folding loosens the searching criteria to maximize the usage of all the related sources. To make the final result match exactly the searching criteria set by the end users, the query transformation should filter the results from MSN™ based on the requested car type. In the above example, only the results about “Acura CL” cars at MSN™ are used in the final result. This is feasible because make and model are returned as part of the result set and thus can be used to filter out results that do not satisfy the original query.

The above four rules present the equivalence mapping and entity folding at both abstract model level and instance level. The following three rules deal with either the property transformation or instance transformation required in the automobile ontology used for used car searching.

2.2.5 Inequality Inference for Abstract Model

One fundamental difference between full-featured databases and web services is that web services have only limited query capabilities. Therefore, dealing with inequality queries is an important problem when using web services to wrap web information sources.

For a conceptually identical attribute, some sources accept equality queries, while others use range searching. For a range search on an attribute, a service may allow the range to have one open-end or both ends open. In any case, the semantic analysis on each service's query capability for the attribute is necessary.

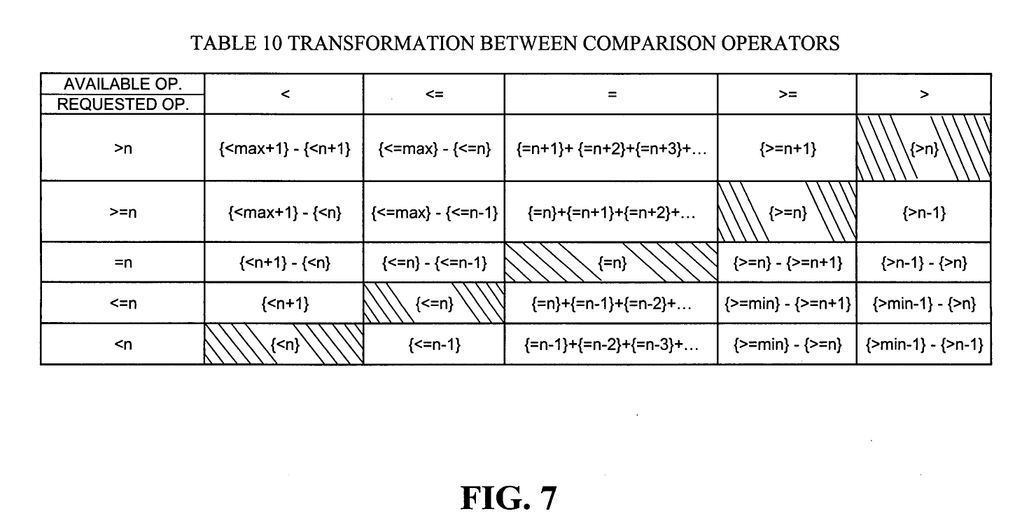

In general, a web service may not offer a full set of comparison operators for an attribute, but a users query may consist of any comparison operator. Table 10 in FIG. 7 lists a complete set of transformations from a user requested operator to an available operator to a web service. In table 10, {} denotes a set returned from using a certain constraint, {}+{} denotes a set union operation, {}−{} denotes a set difference, and n+1 and n−1 are numeric calculations. The shaded (with hatch lines) cells in table 10 are identical mappings when query capability of web service satisfies that of the user query.

In the application considered in this illustrative embodiment, the inequality query capability is annotated using semantic information with the property name in our system. For example, the class “Car Price Range” has two properties, namely, “Price Less Than” and “Price Greater Than,” that describe a range search on car price with two open ends. The semantic meaning of the comparison operators “>” and “<” are encoded as the strings “Greater Than” and “Less Than,” respectively.

When a user's query includes the part “Where price<20000,” the statement is transformed as “Price Less Than=20000” in the query to the corresponding web services. Similarly, a user's query using the operator “>” is transformed to “Price Greater Than=.”

2.2.6 Rule-Based Reasoning for Abstract Model

Some information about the relations between different concepts cannot be described using ontology language and needs to be represented and stored in another knowledge base. One example of the knowledge that cannot be represented using RDFS and OWL is the mathematical relations between the concepts.

For example, MSN™ accepts queries on car's age, while Yahoo™ service allows searching a car based on the upper bound and the lower bound of a car's production year. A mathematical transformation is required between the two concepts “Car age” and “Year MoreThan”:

Year MoreThan=Current Year—Car age

Where

Current Year=2004

The above rule correlates the mathematical relation between “Car age” and “Year From” via a constant “Current Year.” Using this rule, the user query:

Where Car Age<6

is interpreted into the following query to Yahoo™:

Where Year LessThan=2004

and Year MoreThan =1998.

2.2.7 Mismatch Handling in Searchable Attributes

It is possible that the attributes specified in the user's query are not searchable via the web service interface. There are two types of reasons for this mismatch. The first reason is that the attribute set in the user's query does not match that used by a web service, which we call domain mismatch. Another reason is that the range of an attribute in the user's query is different from that for a web service, which we call range mismatch.

In domain mismatch, the web service interface requires values for attributes not specified in the user's query, or an attribute constraint specified in the user's query is not available in the web service interface.

In the case of a missing required attribute in the user's query, the required value can be defaulted, if a default value is supplied in the annotation for the web service. In an illustrative implementation, the default value of each property can be defined using the “a:defaultValues” attribute in RDFS. If no default is supplied, it is desirable to return all results, independent of the value for this required parameter. If there is a “wild card” or “any” value allowed for this attribute, it should be used. Otherwise, the query should be run with each possible value of the required attribute, if the range of the attribute is a limited set, and the results combined.

In the case of an attribute constraint specified in the user's query, that is not available in the web service interface input, the constraint on the attribute is ignored when generating the query. This will return a super set of the requested results. If the value of the attribute can be returned in the result set, then post processing can be done to filter the results that do not match the user's constraint, such as the approach described above in an instance folding transformation.

The range mismatch happens when the range of an attribute of a user's query is different from that of web service. In this scenario, the value of an attribute in the user's query should be mapped to the closest valid value for the web service so that the returned result is a superset of the result of the original user query.

For example, a web service interface may allow only discrete pre-defined values for an attribute, but a user's query may give any value on the attribute. When a user's query includes a parameter value on an enumerated property for a web service, the value should be mapped to the closest enumerated value so that the user's searching range is extended to the closest valid range that contains the original searching range. Post-process is done to filter the invalid results for the original user query. The RDFS has no capability to describe enumerated values, but the enumerated values can be defined using the “OWL:one of” attribute.

2.3 Generating Executable Query to DB2 II

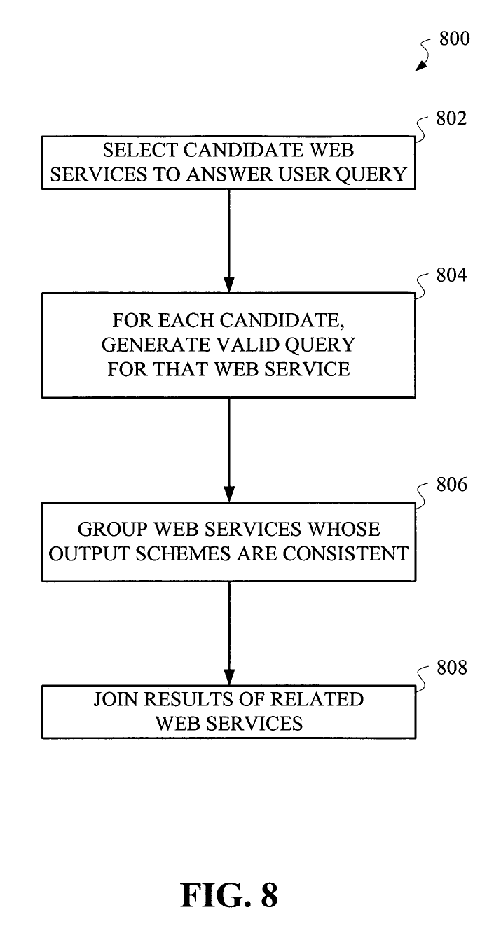

After query transformation, the query generator in FIG. 1 generates a DB2 II query on multiple web services. In one illustrative embodiment, as shown in FIG. 8, query generation process 800 comprises four steps.

Given a user's query, the first step (802) is choosing the candidate web services to answer the query. A candidate web service should have outputs that overlap with the expected results of the user query. Beside that, all the required input attributes of the service can be filled with the user's query.

In the second step (804), for each candidate, a valid query is generated for that web service.

This illustrative implementation assumes two relations between different sources that can collectively serve a user's query. In the first case, the sources generate complementary information on the same properties.

The third step (806) of the query generation is to group the services whose output schemas are consistent. We call two schemas consistent if they are equivalent or one schema contains the other schema. In this illustrative implementation, the resulting schema of a service group is the intersection of the output schemas of all the services in the group. The results of each service group are merged using the statement “UNION ALL.” For example, the output schema of MSN™ contains that of Yahoo™ after the query transformation. Hence, the queries on Yahoo™ and MSN™ can be merged using UNION ALL.

The fourth step (808) is to deal with the second case regarding the relations between services. In this case, the output schemas of some web services are complementary to those of other services, in which case the query generator joins the results of those services together. For example, “KBB Suggested Price” is unique information that is provided by KBB™only. Hence, the query result of KBB™ is joined with that of Yahoo™ and MSN™.

It is to be appreciated that the above-described query composition mechanism can be used to dynamically integrate services with any schema patterns. Alternatively, when there is a priori knowledge about the possible service schema prototypes, we can predefine the service group and only identify the group for each service entity on fly. Advantageously, since the composition mechanism is fixed for given prototypes, the approach using service prototype requires a simpler query composition algorithm than the dynamic composition approach.

3. Example of Transforming User Query to DB2 II Query

This section illustrates the query transformation from a user's query on used cars to a query on DB2 II which integrates three web services Yahoo™, MSN™ and KBB™.

Assuming a user's query as a SQL statement as follows:

SELECT * from car
WHERE Make = Acura
and Model = CL
and Year < 8
and Price < 20000
and Price > 10000
and Mileage < 70000
and Location = 10598

the resulting query on DB2II is as follows:

Create two virtual tables
WITH cars_0 (year, kbb_price, car type) AS
(SELECT KBB_CarYearIs,
KBB_SuggestedPrice, KBB_CarTypels
FROM KBB
WHERE KBB_CarType.Car Make =
Acura, KBB_CarType.Car_Model = CL)
WITH cars_1 (year, price, mileage, car_type) AS
(
(SELECT Yahoo_CarYearIs,
Yahoo_AskedPricels, Yahoo_CarMileageIs,
Yahoo_CarType
FROM Yahoo
WHERE Yahoo_CarMake = Acura AND
Yahoo_Car_Model =C AND
Yahoo_MileageLessThan = 70000 AND
Yahoo MileageMore Than= (0) AND
Yahoo_PriceRange.PriceLessThan =
20000, Yahoo_PriceRange.PriceMoreThan =
10000 AND Yahoo_Search Within = (50) AND
Yahoo_UserPosition = 10598 AND
Yahoo_YearLess Than = (2004) AND
Yahoo_YearMoreThan = 1996)
UNION ALL
(SELECT MSN_YearIs, MSN_AskedPricels,
MSN_Mileagels, MSN_CarTypels
FROM MSN
WHERE MSN_CarAgeLessThan = 8 AND
MSN_CarCategory = PassengerCars AND
MSN_Cartype.Car Make =
Acura, MSN_CarType.CarModel= CL
AND MSN MileageLessThan = 70000 AND
MSN_PriceRange.PriceLessThan =
20000, MSN_PriceRange.PriceMoreThan = 10000
AND MSN_Search Within = (100) AND
MSN_UserAt= 10598)
Join virtual tables and select desired results
SELECT c0.year, c0.kbb_price, c0.car_type,
cl.year, cl.price, cl.mileage, cl.car_type
FROM
cars_0 c0 cars_1 ci
WHERE
c0.year = cl.year AND c0.car_type = cl.car_type

In the above statements, the italicized fields are the attributes that use the default values. The user query is transformed into the queries to the three resources using the following statements:

SELECT . . . FROM Yahoo or MSN or KBB

A WITH statement defines a virtual table that corresponds to a group of services that generate consistent outputs. The first WITH statement defines a group of services that include KBB™ only. This group provides the result on KBB Suggested Price that is not provided by other groups. The second group merges the results of Yahoo™ and MSN™ using the UNION ALL statement.

The last SELECT statement in the above DB2 II query joins the results from two virtual tables, each of which provides partial answer to the user's query.

4. Illustrative Computing System

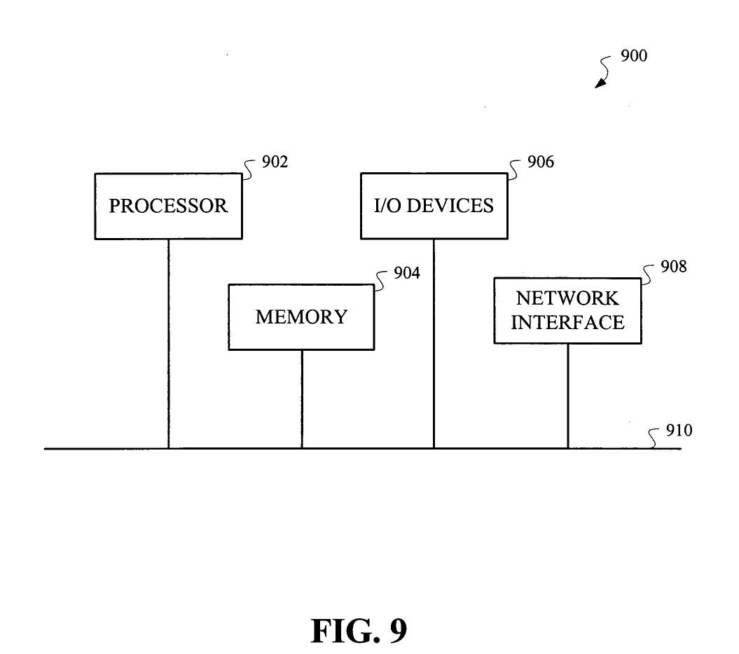

Referring finally to FIG. 9, a computing system in accordance with which one or more components/steps of an information integration system (e.g., components and methodologies described in the context of FIGS. 1 through 8) may be implemented, according to an embodiment of the present invention, is shown. It is to be understood that the individual components/steps may be implemented on one such computer system or on more than one such computer system. In the case of an implementation on a distributed computing system, the individual computer systems and/or devices may be connected via a suitable network, e.g., the Internet or World Wide Web. However, the system may be realized via private or local networks. In any case, the invention is not limited to any particular network.

Thus, the computing system shown in FIG. 9 represents an illustrative computing system architecture for implementing, among other things, one or more functional components/steps of information integration system 100 (FIG. 1), e.g., a query transformation engine, a query generator, ontology store, knowledge base store, back-end database, etc. Further, the computing system architecture may also represent an implementation of one or more of the client devices from which user queries originate, and/or one or more of the information sources (e.g., web sources).

As shown, the computing system architecture 900 may comprise a processor 902, a memory 904, I/O devices 906, and a communication interface 908, coupled via a computer bus 910 or alternate connection arrangement. In one embodiment, the computing system architecture of FIG. 9 represents one or more servers associated with service provider.

It is to be appreciated that the term “processor” as used herein is intended to include any processing device, such as, for example, one that includes a CPU and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc.

In addition, the phrase “input/output devices”or “I/O devices” as used herein is intended to include, for example, one or more input devices (e.g., keyboard, mouse, etc.) for entering data to the processing unit, and/or one or more output devices (e.g., display, etc.) for presenting results associated with the processing unit.

Still further, the phrase “network interface” as used herein is intended to include, for example, one or more transceivers to permit the computer system to communicate with another computer system via an appropriate communications protocol.

Accordingly, software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

In any case, it is to be appreciated that the techniques of the invention, described herein and shown in the appended figures, may be implemented in various forms of hardware, software, or combinations thereof, e.g., one or more operatively programmed general purpose digital computers with associated memory, implementation-specific integrated circuit(s), functional circuitry, etc. Given the techniques of the invention provided herein, one of ordinary skill in the art will be able to contemplate other implementations of the techniques of the invention.

Accordingly, as explained herein, principles of the invention provide an information integration framework that uses web service as the wrapper to represent heterogeneous web information sources. The framework can be built upon industry standards such as, for example, WSDL/SOAP and ontology languages such as, for example, RDFS and OWL, and leverages the query optimization capability of a commercial database such as, for example, IBM DB2 II.

Using DB2 II as the back-end, by way of example, the system annotates the query capability of the web services using an ontology representation. Using a used car searching service as the application scenario, by way of example, we have identified several types of semantic information as useful in integrating information from web services:

1. Query constraints in each service—some attributes are required in the queries to a web service, while others are optional;

2. Operation constraints on properties—a property can be queried using equality or inequality operators; the range searching can have one open end or two;

3. Relations between attributes—two concepts defined in the ontology of different services can be completely equivalent, or one concept can be the sub-concept of another one;

4. Other constraints on an attribute include the default values and/or the enumerated values.

The semantic-based query transformation of the invention can be used to utilize hidden web sources and integrate the results at the fine-grained level from dynamic and heterogeneous web information sources.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method of processing a query obtained from a user in an information integration system, the information integration system being associated with a database and one or more information sources, the method comprising the steps of:
transforming the user query to one or more queries valid with respect to one or more of the information sources associated with the database; and
generating, based on the one or more transformed queries, a query plan executable on the database, wherein at least a portion of results returned to the user in response to the query are based on at least a portion of results returned from execution of the query plan.

2. The method of claim 1, wherein the one or more of the information sources comprise one or more web services.

3. The method of claim 1, wherein at least one of a number, a nature and an identity of the one or more information sources changes over time.

4. The method of claim 1, wherein the query transformation step further comprises using an ontology language to describe at least one of a concept space of the user, a concept space of the one or more information sources, and relations between different concept spaces.

5. The method of claim 4, wherein the query transformation step further comprises transforming the user query, based on semantic annotations on the one or more information sources, to the one or more valid queries to the one or more information sources by reasoning from the ontology.

6. The method of claim 4, wherein the query transformation step further comprises using a knowledge base for describing information that cannot be described using the ontology language.

7. The method of claim 6, wherein the knowledge base describes information relating to mathematical relations between concepts.

8. The method of claim 1, wherein the query transformation step further comprises a concept mapping operation.

9. The method of claim 1, wherein the query transformation step further comprises an instance mapping operation.

10. The method of claim 1, wherein the query transformation step further comprises a concept folding operation.

11. The method of claim 1, wherein the query transformation step further comprises an instance folding operation.

12. The method of claim 1, wherein the query transformation step further comprises an inequality inference rule.

13. The method of claim 1, wherein the query transformation step further comprises a knowledge-based reasoning rule.

14. The method of claim 1, wherein the query transformation step further comprises a rule for handling a mismatch in a searchable attribute.

15. The method of claim 1, wherein the executable query plan generation step further comprises selecting candidate information sources to answer the user query.

16. The method of claim 15, wherein the executable query plan generation step further comprises generating a valid query for each candidate information source.

17. The method of claim 16, wherein the executable query plan generation step further comprises grouping information sources whose output schema are consistent.

18. The method of claim 17, wherein the executable query plan generation step further comprises joining results associated with related information sources.

19. Apparatus for processing a query obtained from a user, comprising:
a memory; and
at least one processor coupled to the memory and operative to: (i) transform the user query to one or more queries valid with respect to one or more information sources associated with a database; and (ii) generate, based on the one or more transformed queries, a query plan executable on the database, wherein at least a portion of results returned to the user in response to the query are based on at least a portion of results returned from execution of the query plan.

20. An article of manufacture for processing a query obtained from a user in an information integration system, the information integration system being associated with a database and one or more information sources, comprising a machine readable medium containing one or more programs which when executed implement the steps of:
transforming the user query to one or more queries valid with respect to one or more of the information sources associated with the database; and
generating, based on the one or more transformed queries, a query plan executable on the database, wherein at least a portion of results returned to the user in response to the query are based on at least a portion of results returned from execution of the query plan.
